(19) United States
(12) Patent Application Publication
(10) Pub. No.: US 2006/0214471 A1
(43) Pub. Date: Sep. 28, 2006

(54) Attachment system for modules in a vehicle

(75) Inventors: Rick A. Anderson, Grand Haven, MI (US); Andrew K. Ruiter, Grand Haven, MI (US); Thomas S. Hodgson, Holland, MI (US); Mathias R. Fox, Zeeland, MI (US); Steven M. Spoerre, Holland, MI (US); Matthew A. Kalis, Hudsonville, MI (US); Kermit M. Anderson, Holland, MI (US); Bryan T. Jones, Holland, MI (US); Mark P. Kadzban, Grandville, MI (US); Joseph M. Thompson, Holland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 10/552,980

(22) PCT Filed: May 5, 2004
(86) PCT No.: PCT/US04/13880

§ 371 Date: Oct. 12, 2005

Related U.S. Application Data
(60) Provisional application No. 60/468,508, filed on May 7, 2003.
(60) Provisional application No. 60/501,934, filed on Sep. 11, 2003.

(51) Int. Cl. B60J 7/00

(52) U.S. Cl. 296/187.01; 296/24.34

(57) ABSTRACT

An attachment system for coupling a module to a rail member on an interior portion of a vehicle is disclosed and includes a latching member. The latching member includes a projection configured to operably engage the rail member by rotation of the lever. An attachment system for coupling a module to a vehicle is also includes a latch device having a hook member pivotally coupled to a lever so that movement of the lever operates the hook as an over-center device to releasably engage the rail member. An attachment system also includes a flange extending from the latch device and configured to engage a recess on the rail member

### CROSS REFERENCE TO RELATED APPLICATIONS

The present Application claims the benefit of priority, as available under 35 U.S.C. § 119(e)(1), to U.S. Provisional Patent Application Nos. 60/468,508 titled “Attachment System for Modules in a Vehicle” filed on May 7, 2003 and 60/501,934 titled “Latch for Rail System” filed on Sep. 11, 2003 (which are incorporated by reference in their entirety).

### FIELD

The present invention relates to an attachment system for modules for a vehicle. The attachment system is configured for interchangeably attaching modules for use in a vehicle. The modules for configured for use with rails of an overhead system for a vehicle.

### BACKGROUND

Placement of modules for use in an overhead location or other location of a vehicle are generally known and may include one or more modules such as storage compartments, bins, instrumentation, entertainment devices and the like. The modules are typically formed with (or attached to) a console or other trim piece, in which the modules are often permanently, or semi-permanently, attached to the internal structure of the vehicle by attachment devices such as threaded fasteners, spring-clips or the like.

However, the attachment devices typically are not intended to permit a user to conveniently remove one module and replace it with another module. The known attachment devices also do not usually provide a user with the capability to rearrange the position of several modules, or to customize the content and position of the modules within the vehicle in a convenient manner.

Accordingly, it would be advantageous to provide an attachment system for modules that provides secure retention of the module within the vehicle. It would also be advantageous to provide an attachment system for a vehicle that provides secure retention of the module in a vertical direction and a horizontal direction. It would also be advantageous to provide an attachment system for modules that permits the module to be easily and conveniently installed, removed, or replaced with other modules. It would be further advantageous to provide an attachment system for modules that is configured for concealment within the module to enhance the aesthetic appearance of the module. It would be further advantageous to provide an attachment system for modules that is configured to fit within a compartment along a surface of the module to minimize inadvertent contact with the attachment system.

Accordingly, it would be advantageous to provide an attachment system for a module having any one or more of these or other advantageous features.

### SUMMARY

The present invention relates to an attachment system for coupling a module to a rail member on an interior portion of a vehicle and includes a module having a latching device attached thereto. The latching device includes a lever pivotally coupled to a pin and configured to operably engage a recess on the rail member by a quarter-turn of the lever.

The present invention also relates to an attachment system for coupling a module to a vehicle and includes a rail member positioned along an interior surface of the vehicle. A module is configured to be releasably positioned on the rail member, and a pin member is coupled to the module and has a hook configured to releasably engage the rail member when the pin member is rotated approximately 90 degrees.

The present invention further relates to an attachment system for coupling a module to a vehicle and includes a rail member positioned along an interior surface of the vehicle and a module configured to be releasably positioned on the rail member. A latch device is configured to couple the module to the rail member. The latch device has a hook member pivotally coupled to a lever so that movement of the lever operates the hook as an over-center type device to releasably engage the rail member.

The present invention further relates to an attachment system for coupling a module to a vehicle and includes a rail member positioned along an interior surface of the vehicle and a module configured to be releasably positioned on the rail member. A latch device is configured to couple the module to the rail member. The latch device has a flange portion that is biased to coact with a recess on the rail member when the module is positioned on the rail member.

### BRIEF DESCRIPTION OF THE DRAWINGS

FIG. 1 is a schematic representation of a front perspective view of a module attached to an interior structure of a vehicle according to an exemplary embodiment.

FIG. 2 is a schematic representation of a bottom view and an end view of an interior structure of a vehicle of the embodiment of FIG. 1 according to an exemplary embodiment.

FIG. 3 is a schematic representation of an exploded back perspective view of an attachment system for a module for a vehicle according to one embodiment.

FIG. 4 is a schematic representation of a perspective view of a portion of the attachment system for a module according to the embodiment of FIG. 3.

FIG. 5 is a schematic representation of a perspective view of a portion of the attachment system for a module according to the embodiment of FIG. 3.

FIG. 6 is a schematic representation of a perspective view of a portion of the attachment system for a module according to the embodiment of FIG. 3.

FIG. 7 is a schematic representation of a perspective view of a portion of the attachment system for a module according to the embodiment of FIG. 3.

FIG. 8 is a schematic representation of a front perspective view of an attachment system for a module according to another embodiment.

FIG. 9 is a schematic representation of a front view of an attachment system for a module according to the embodiment of FIG. 8.

FIG. 10 is a schematic representation of an exploded perspective view of an attachment system for a module according to the embodiment of FIG. 8.

FIG. 11 is a schematic representation of a cross sectional view of an attachment system for a module according to the embodiment of FIG. 8.

FIG. 12 is a schematic representation of an exploded perspective view of an attachment system for a module according to the embodiment of FIG. 8.

FIG. 13 is a schematic representation of an exploded perspective view of an attachment system for a module according to the embodiment of FIG. 8.

FIG. 14 is a schematic representation of a front perspective view of an attachment system for a module according to another embodiment.

FIG. 15 is a schematic representation of a cross sectional view of an attachment system for a module according to the embodiment of FIG. 14.

FIG. 16 is a schematic representation of a perspective view of a portion of an attachment system for a module according to the embodiment of FIG. 14.

FIG. 17 is a schematic representation of a cross sectional view of an attachment system for a module according to an alternative of the embodiment of FIG. 14.

FIG. 18 is a schematic representation of a cross sectional view of an attachment system for a module according to the embodiment of FIG. 17.

FIG. 19 is a schematic representation of a perspective view of a portion of an attachment system for a module according to the embodiment of FIG. 17.

FIGS. 20A through 20C are schematic diagrams of an attachment system in various stages of deployment for a module according to another embodiment.

FIG. 21A is a schematic representation of a front perspective view of an attachment system for a module according to another embodiment.

FIG. 21B is a schematic representation of a top view of a portion of the attachment system according to the embodiment of FIG. 21A.

FIG. 21C is a schematic representation of a cross sectional view of a portion of the attachment system according to the embodiment of FIG. 21A.

FIG. 22 is a schematic representation of an exploded perspective view of the attachment system according to the embodiment of FIG. 21A.

FIG. 23 is a schematic representation of a perspective view of an attachment system for a module according to another embodiment.

FIG. 24 is a schematic representation of a cross sectional view of the attachment system according to the embodiment of FIG. 23.

### DETAILED DESCRIPTION

The attachment system for a module 10 is shown and described for modules configured to attach to a structure along an overhead portion of a vehicle interior (shown schematically as “rails” 20 or other elongated members positioned on an “A” surface of a “headliner” or panel). However, the description of the various embodiments of the attachment system for a module are equally applicable to attachment systems for other locations within a vehicle, such as floor areas, cargo storage areas, seat backs, side panels, etc.

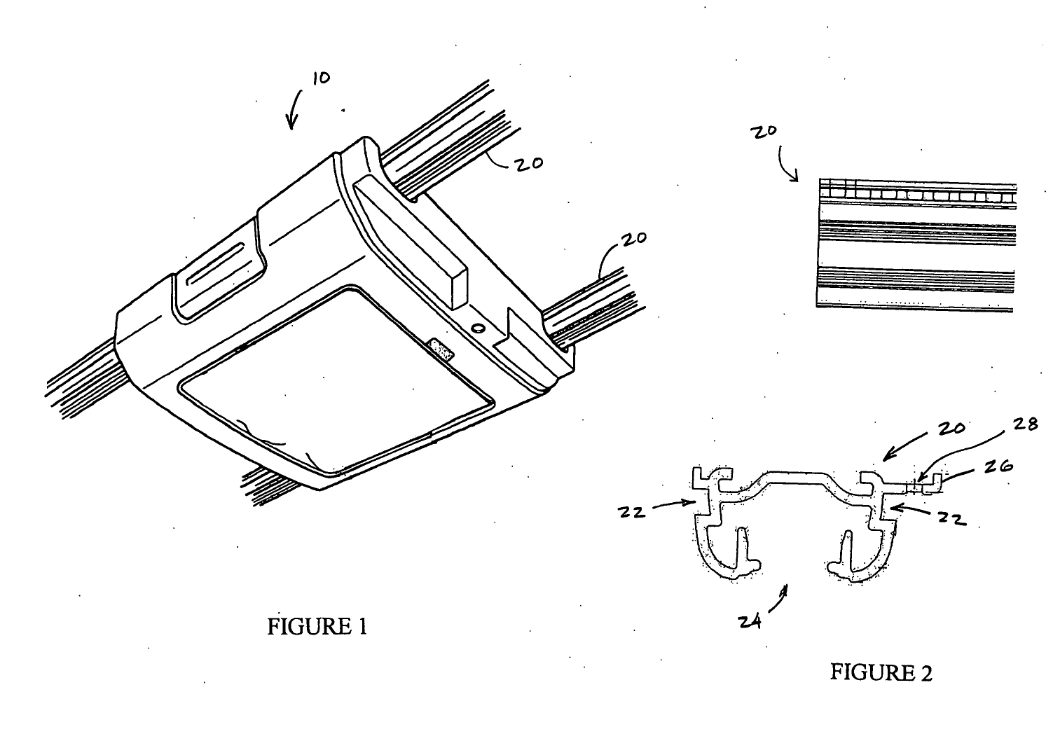

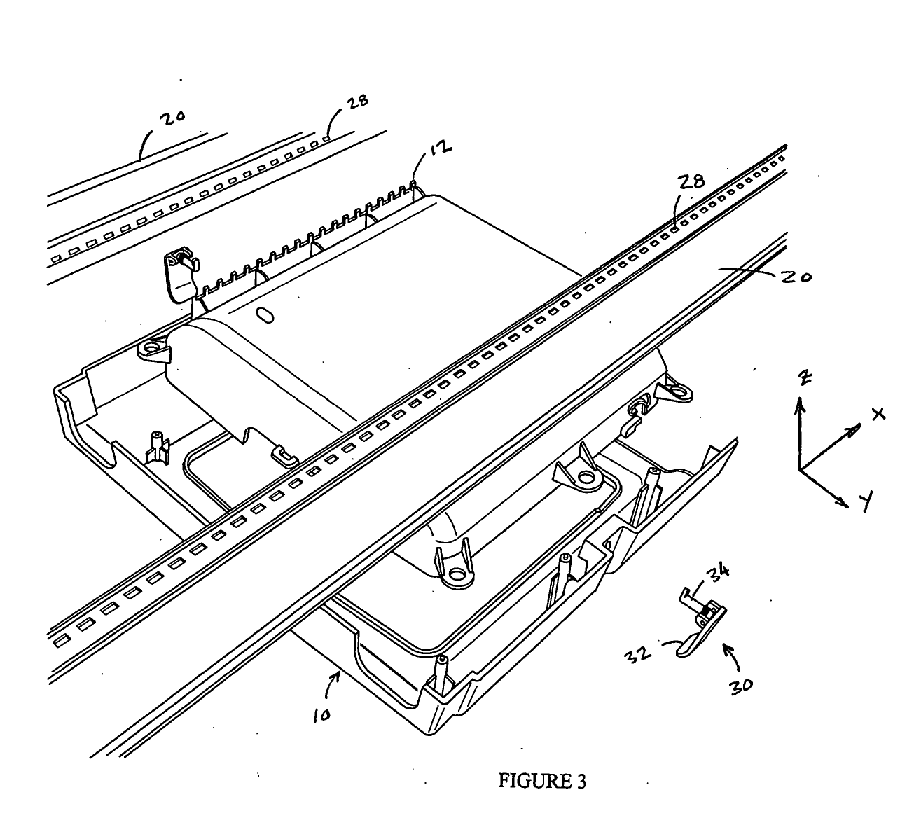

Referring to FIG. 1, a module 10 for use in a vehicle is shown schematically positioned on an overhead panel (such as the A surface of a headliner, etc.) within the vehicle and attached to elongated members shown schematically as rail members 20. The modules are configured to be conveniently installed, removed, replaced and repositioned along the rails by the attachment system. Referring to FIG. 2, one embodiment of the rail member 20 is shown schematically as including recesses 22 that extend longitudinally along a side area, and an opening 24 that extends longitudinally along a lower surface, and a flange member 26 that extends longitudinally along an upper edge and having apertures 28. According to various embodiments of the attachment system, the recesses, openings and/or apertures are configured to coact with structure provided on the modules to permit the modules to be conveniently and securely attached or coupled to the vehicle interior (e.g. such as via the rails). Dimensions for the rail member may be provided in any suitable size and proportion for mounting modules within the vehicle.

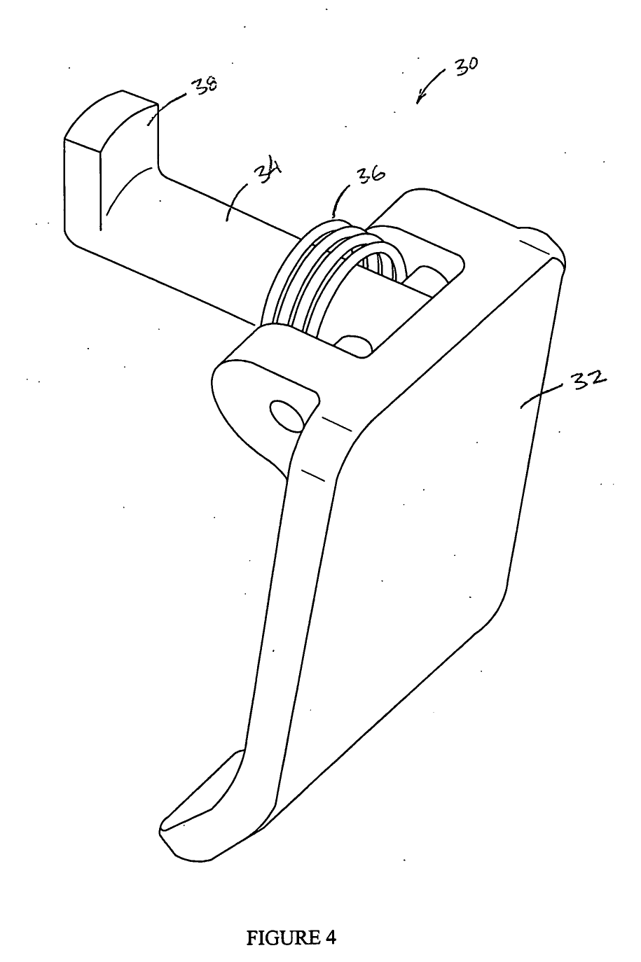

Referring to FIG. 3, an attachment system for a module is shown according to one embodiment. The attachment system includes a latch device 30 positioned on each side of the module 10. The module is shown to include projections 12 shown schematically as “teeth” configured to engage the apertures 28 on the rails 20 that are intended to minimize the tendency of the module to “slide” or otherwise move along the rails (e.g. X-axis direction) during rapid vehicle deceleration or impact events (e.g. collisions, etc.). The latch device 30 is configured to operate as a Y-axis, quarter-turn latching device to secure the modules to the rails and prevent movement of the modules in at least the vertical (e.g. Z-axis direction).

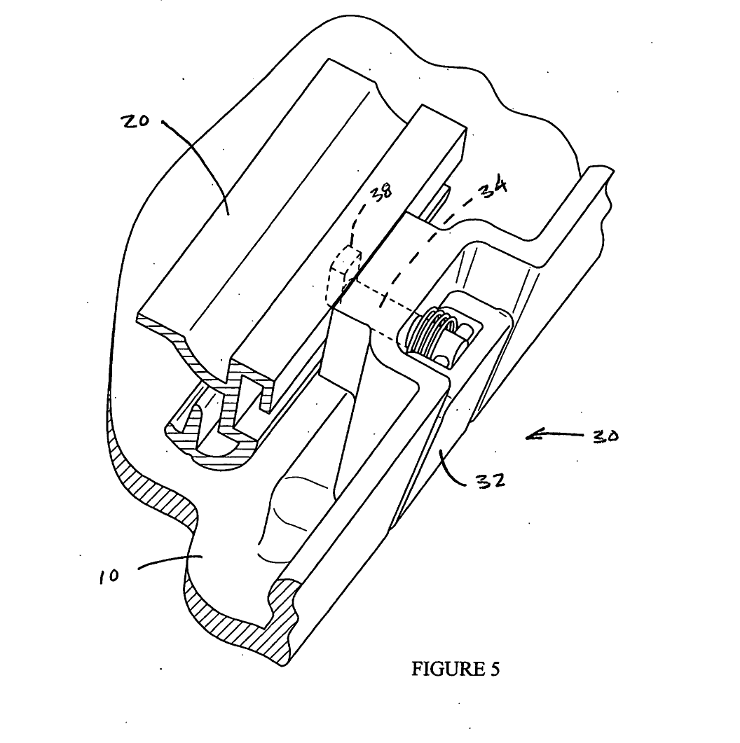

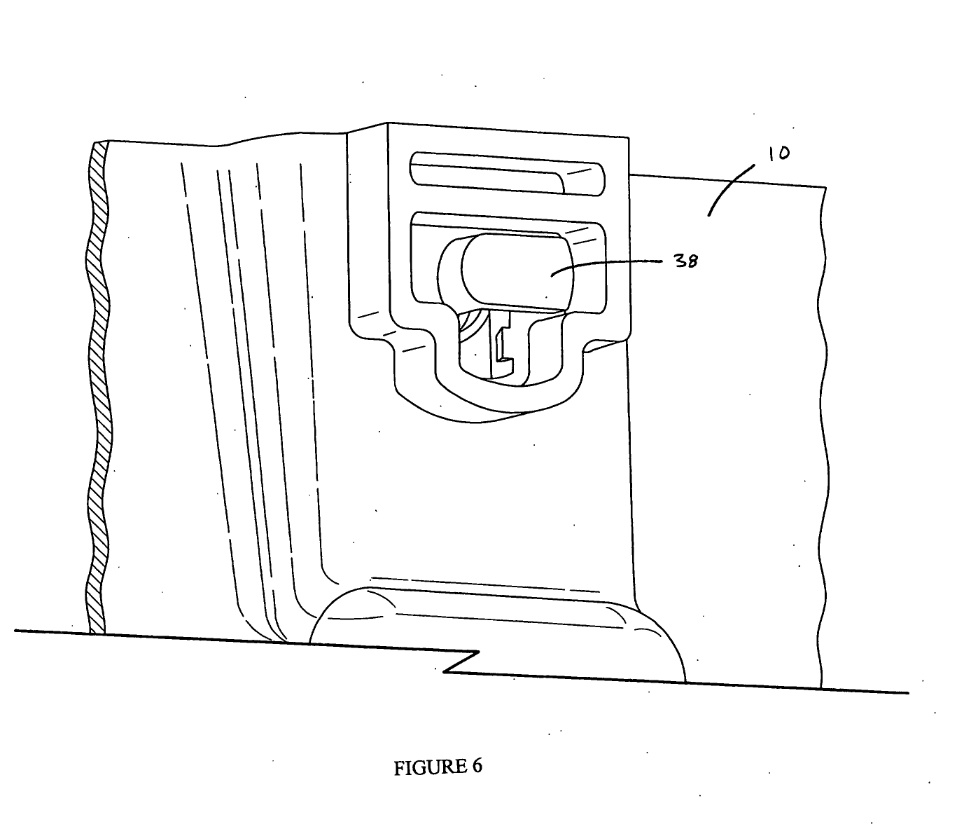

Referring to FIGS. 4 and 5, the latch device 30 is shown having a handle portion 32 (e.g. lever, etc.) pivotally coupled to pin member 34 (e.g. axle, etc.). The pin 34 has a spring member 36 and a projection shown as a “foot” 38 (e.g. hook, lobe, tab, etc.) configured to coact with the recess 22 on the rail 20.

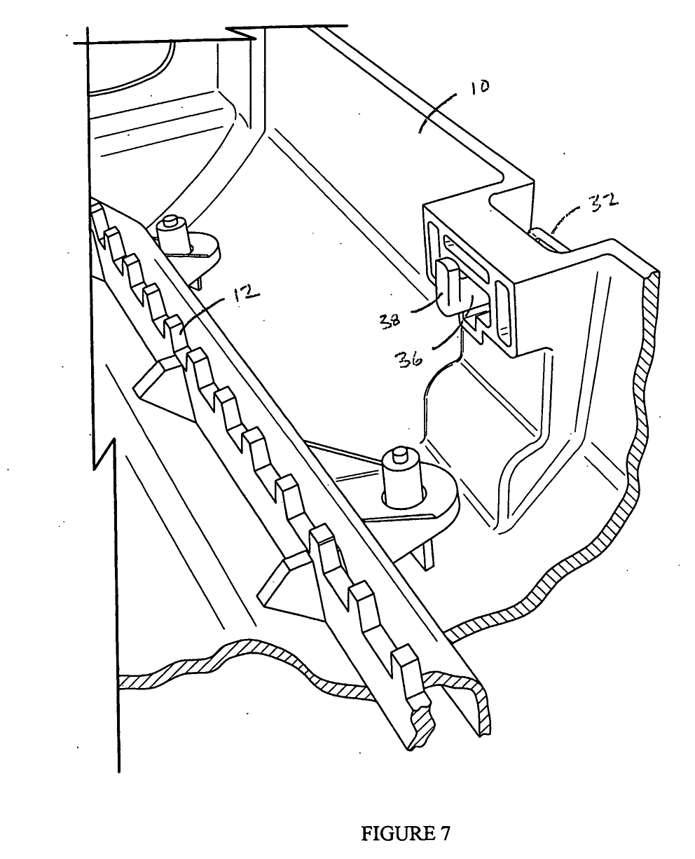

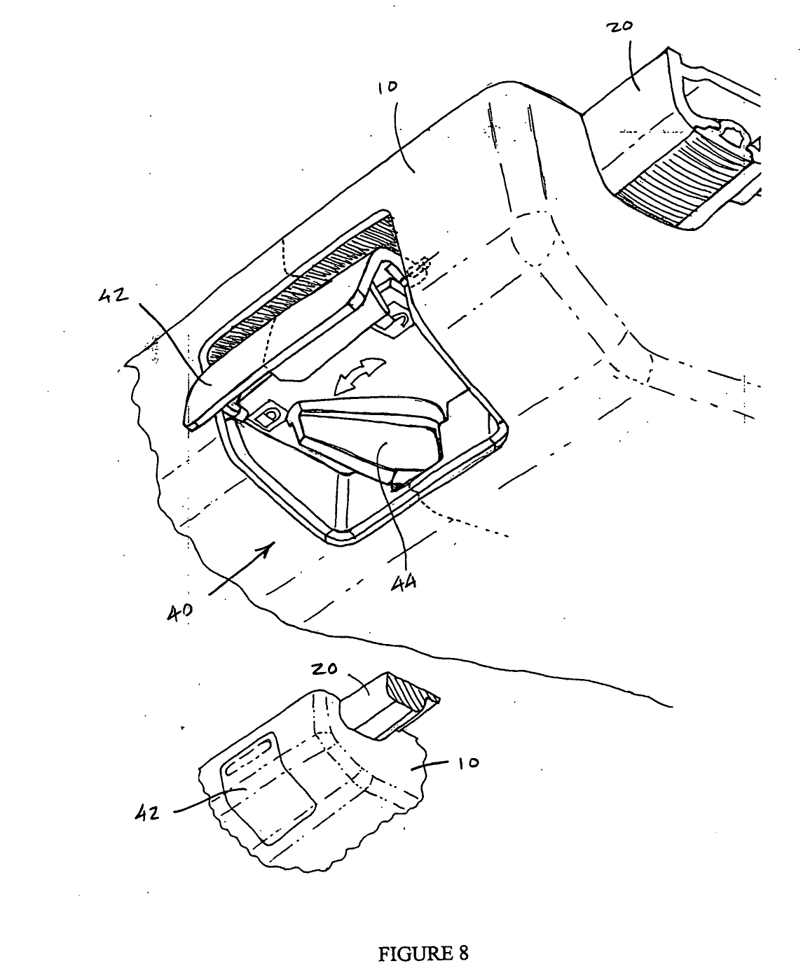

Referring to FIG. 6, the attachment system is actuated by aligning the handle portion 32 axially with the pin member 34 and positioning the handle portion 32 and pin member 34 so that the foot 38 is approximately horizontal and configured to fit into the recess 22 on the rail 20. The handle portion 32 and pin member 34 are moved inwardly against the spring force to position the foot 38 within the recess 22. Referring to FIG. 7, the handle portion 32 is rotated approximately 90 degrees (e.g. a quarter turn) so that the foot 38 is rotated upward within the recess 22, and then the handle portion 32 is rotated downward (approximately 90 degrees) to a stowed position along the side of the module.

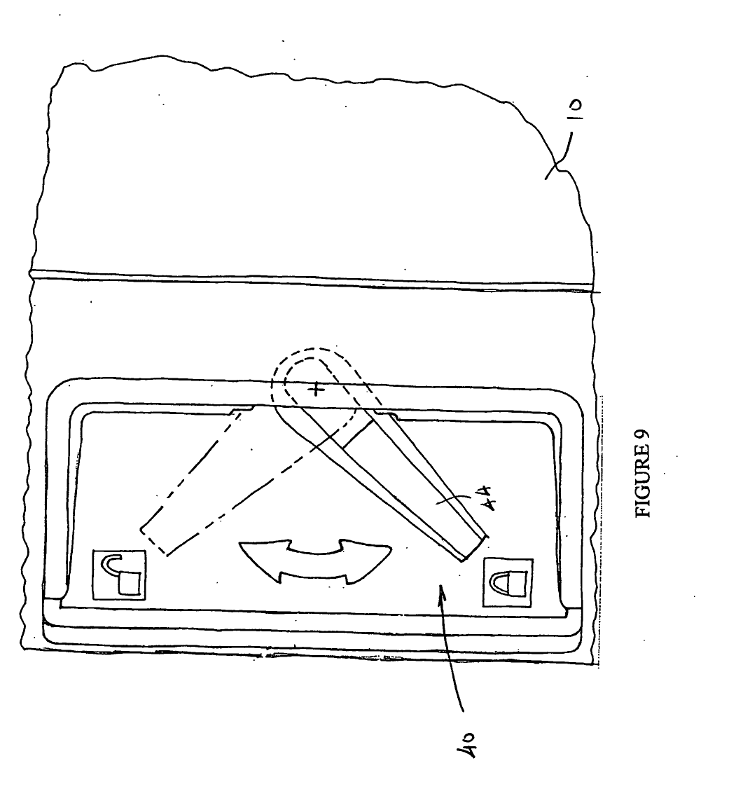

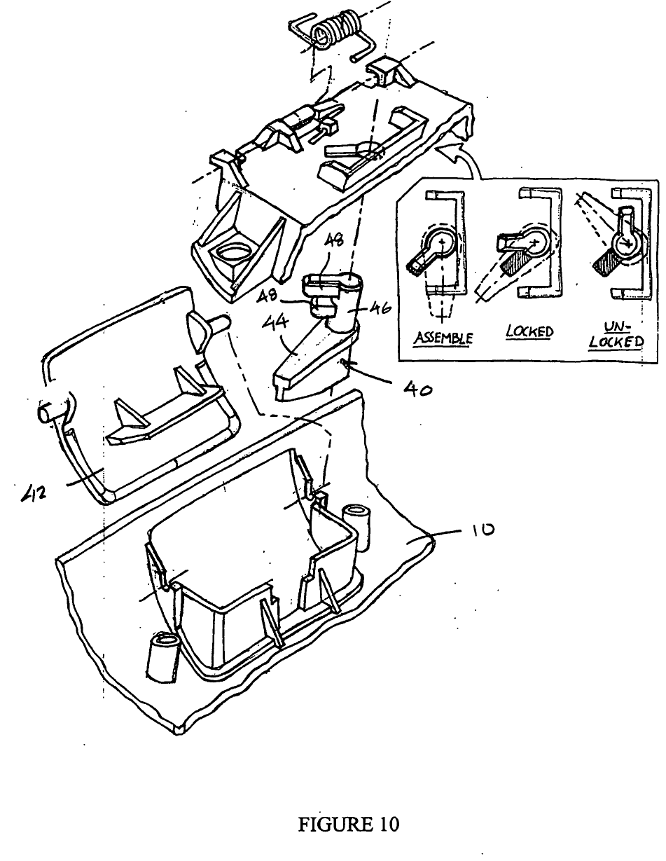

Referring to FIGS. 8 and 9, an attachment system is shown according to another embodiment. The attachment system includes a latch device 40 positioned on one or both sides of the module 10 and positioned for concealment behind a movable panel (shown schematically as a spring-biased, pivotal “door” 42). The latch device 40 is configured to operate as a Z-axis, quarter-turn latching device to secure the module 10 to the rail(s) 20 and prevent movement of the module in at least the vertical (e.g. Z-axis direction).

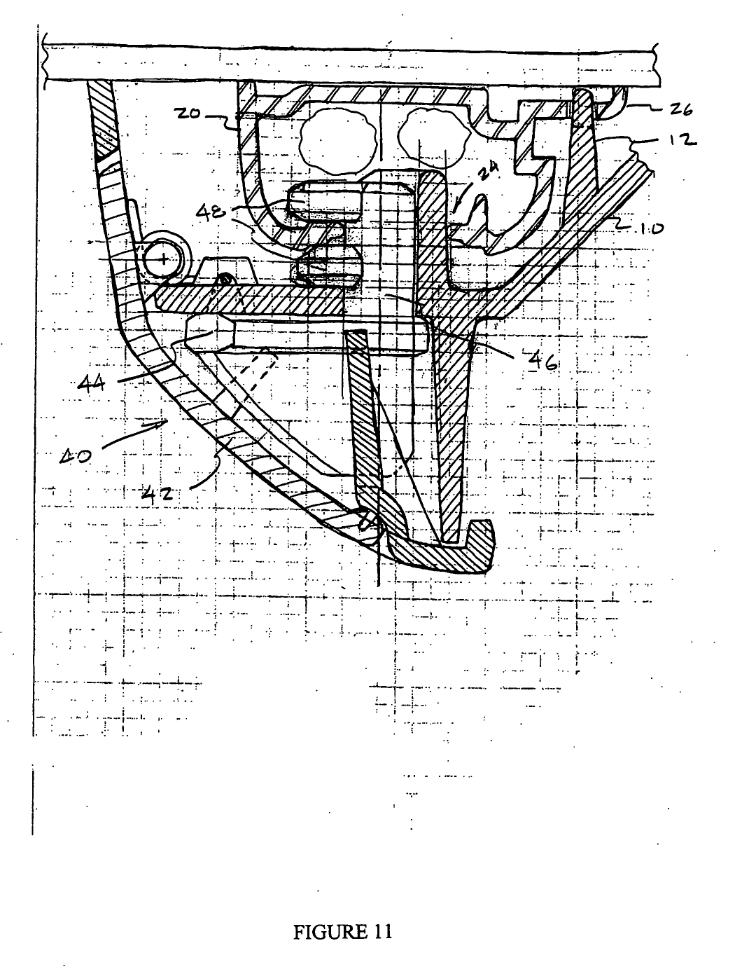

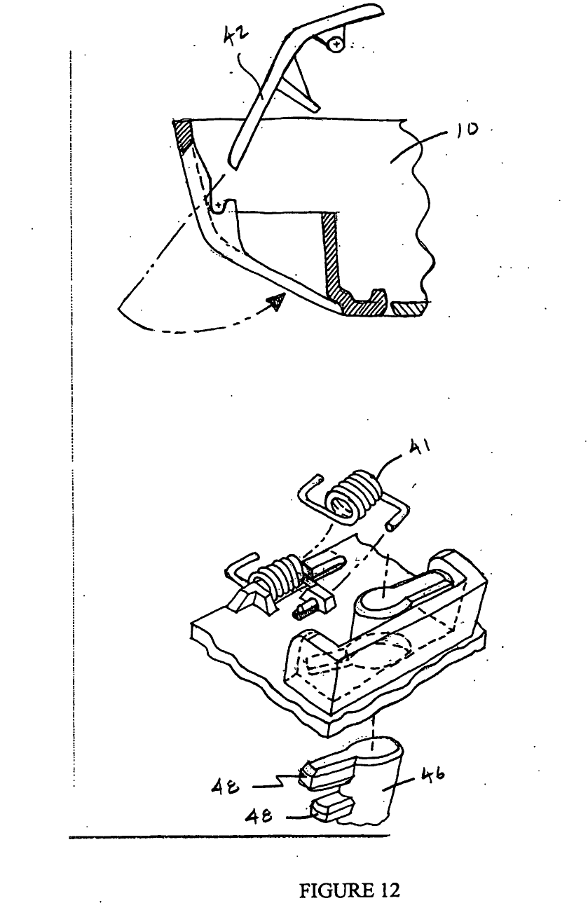

Referring to FIGS. 10 and 11, the latch device 40 has a handle member 44 configured for a quarter-turn rotation by a user to actuate and release the attachment system. The handle member 44 is shown as rigidly (e.g. integrally, etc.) formed with a pin member 46 (e.g. axle, etc.) having two projections shown as “feet” 48 (e.g. lobes, hooks, projections, etc.) extending therefrom. The feet 48 are oriented on the pin member 46 such that the feet 48 are aligned with the opening 24 along the bottom of the rail 20 when the handle member 44 is in the “unlocked” position so that the pin member 46 and feet 48 may enter the opening 24 as the module 10 is positioned onto the rails 20. The handle member 44 may them be rotated approximately 90 degrees to a “locked” position in which the feet 48 are configured to coact with the rail 20 by engaging an inside and outside section of the rail 20. According to alternative embodiments, a single foot may be provided and configured to engage the inside section of the rail, or two feet may be provided and oriented generally opposite each other on the pin member so that the feet engage opposite sections that are inside of the rail.

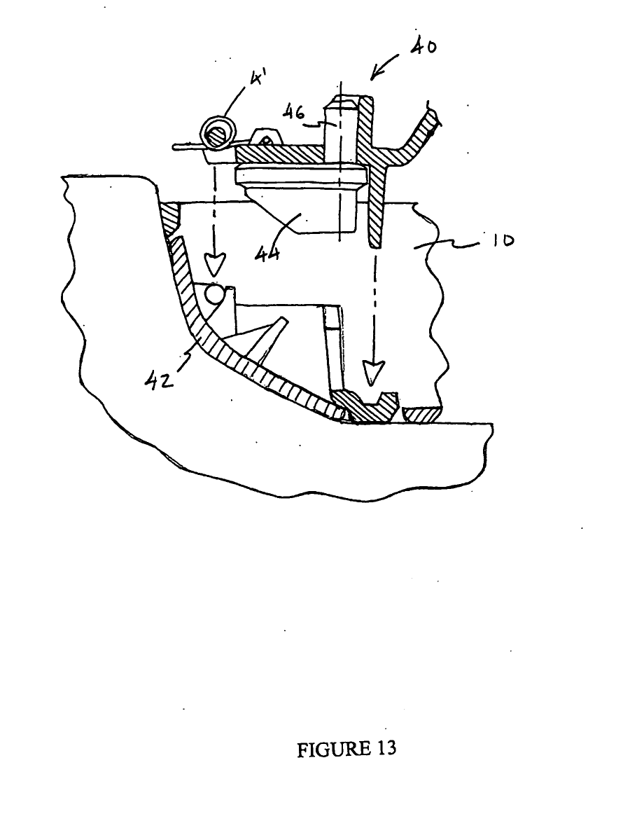

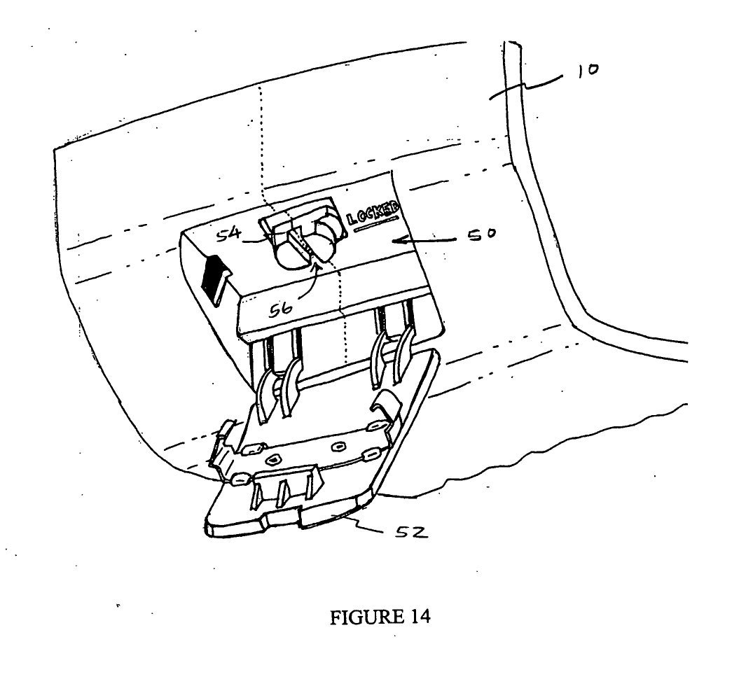

Referring to FIGS. 12 and 13, the attachment system is shown assembled and positioned behind a spring-biased door 42. The door 42 may be pivoted or rotated to provide access to the handle member 44 for actuation of the handle member 44 between the locked position and the unlocked position. A spring 41 is intended to bias the door 42 to a normally “closed” position.

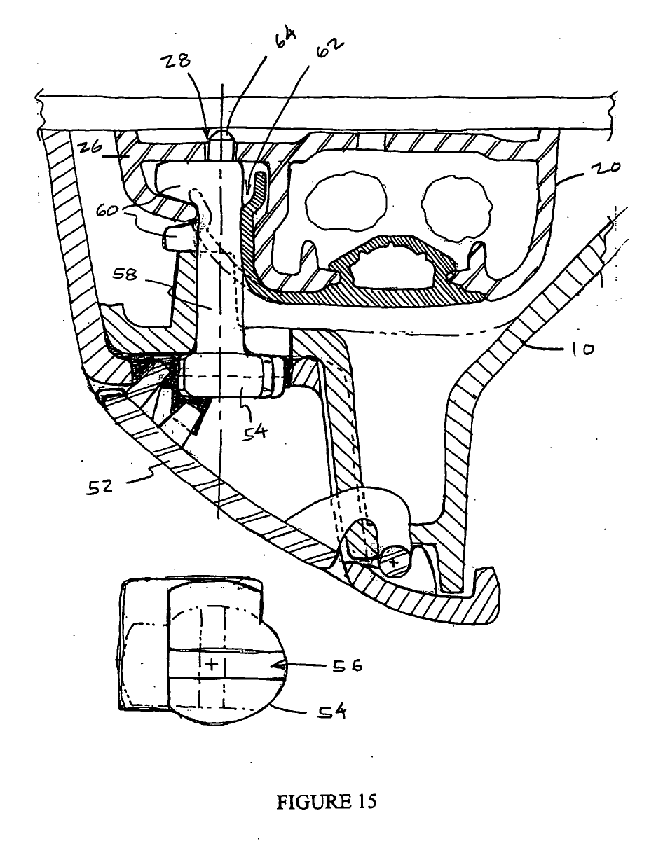

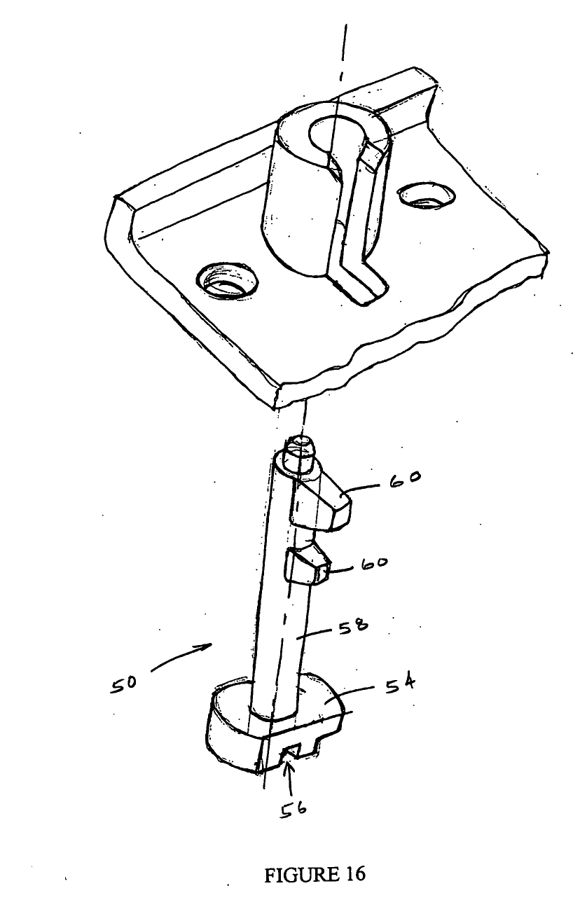

Referring to FIGS. 14 and 15, an attachment system is shown according to another embodiment. The attachment system includes a latch device 50 positioned on one or both sides of the module 10 and positioned for concealment behind a movable panel (shown schematically as a spring-biased, pivotal “door” 52). The latch device 50 is configured to operate as a Z-axis, quarter-turn latching device to secure the module to the rail(s) and prevent movement of the modules in at least the vertical (e.g. Z-axis direction).

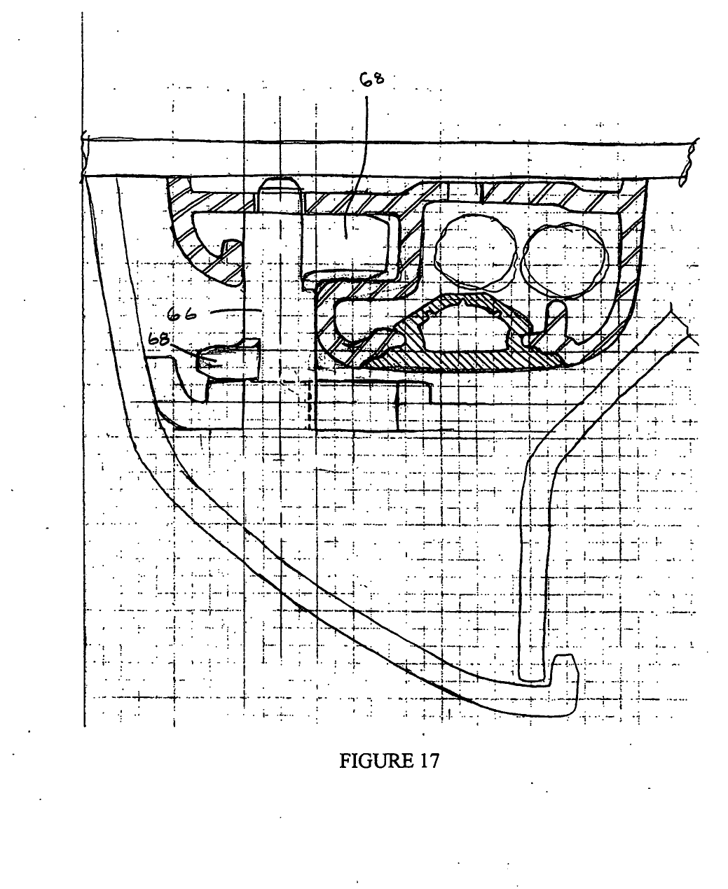

Referring to FIGS. 14 through 16, the latch device 50 has a handle member 54 (shown schematically having a “slot” 56 for receiving a “thin” object such as a coin, etc.) configured for a quarter-turn rotation by a user to actuate and release the attachment system. The handle member 54 is shown as rigidly (e.g. integrally, etc.) formed with a pin member 58 (e.g. axle, etc.) having two projections shown as “feet” 60 (e.g. lobes, projections, etc.) extending therefrom. The feet 60 are oriented on the pin member 58 such that the feet 60 are aligned with an opening 62 along the flange 26 of the rail 20 when the handle member 54 is in the “unlocked” position so that the pin member 58 and feet 60 may enter the opening 62 as the module is positioned onto the rail(s). The handle member 54 may them be rotated approximately 90 degrees to a “locked” position in which the feet 60 are configured to coact with the rail by engaging an inside and outside section of the rail. The pin member 58 also includes an extension 64 configured to engage the apertures 28 on the rail when the module is positioned on the rail(s) and is intended to provide structure that will minimize the tendency of the modules to move or slide along the rails during collisions or other events. According to alternative embodiments, a single foot may be provided and configured to engage the inside section of the rail, or two feet may be provided and oriented generally opposite each other on the pin member so that the feet engage opposite sections that are inside of the rail.

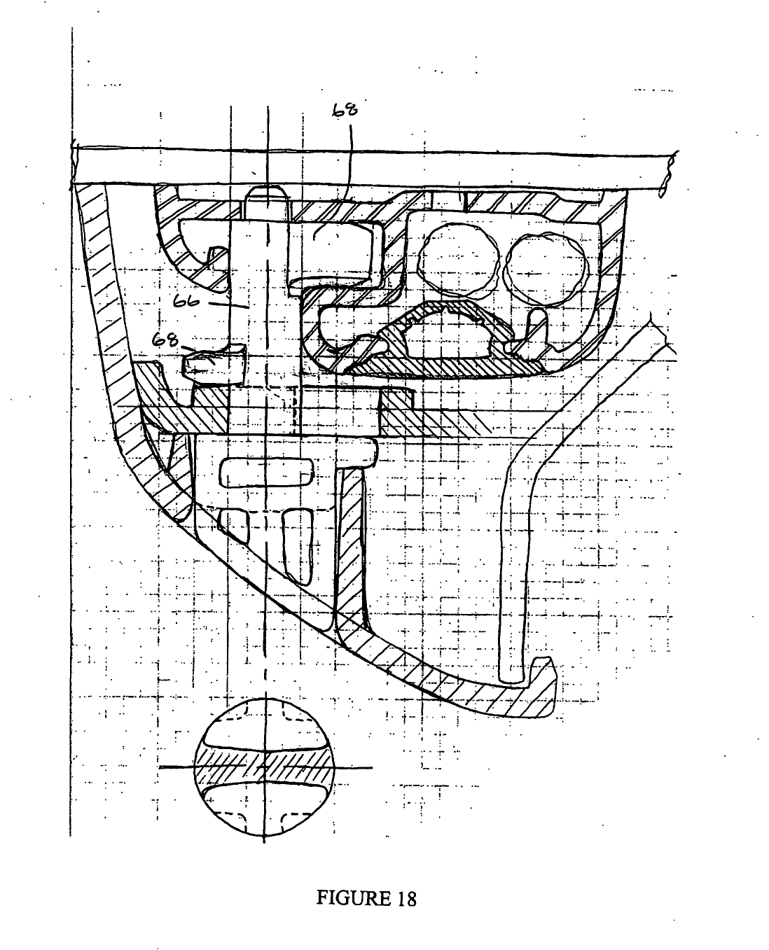

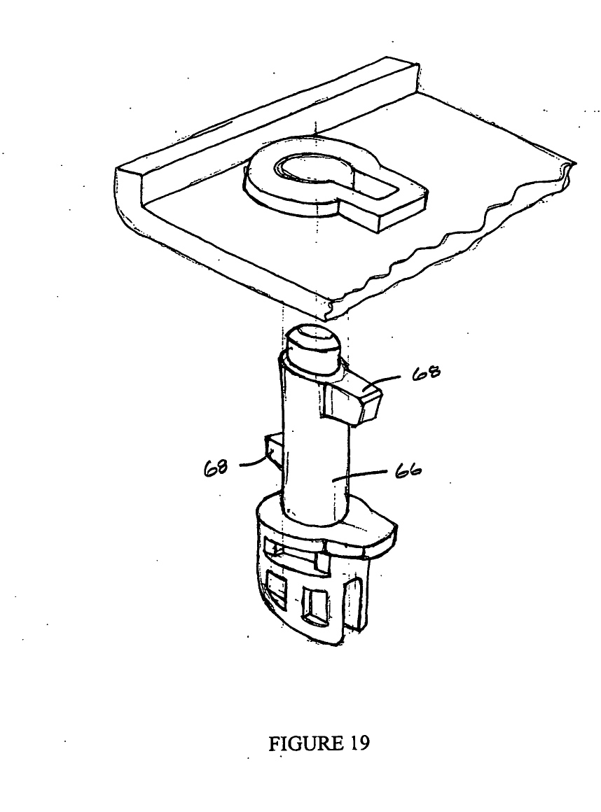

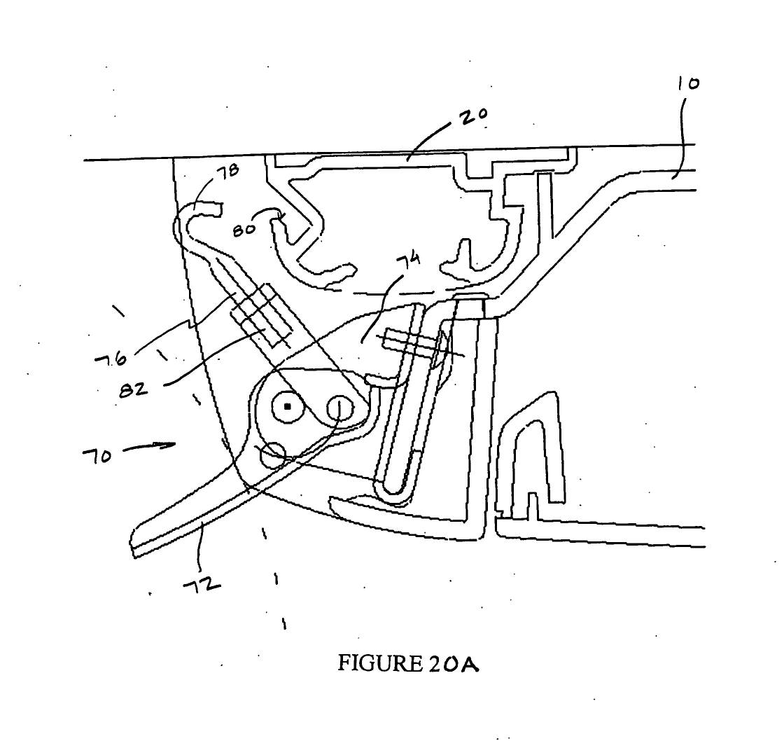

Referring to FIGS. 17 through 19, an attachment system is shown according to an alternative embodiment of the attachment system of FIGS. 14 through 16. As shown schematically, the pin member 66 may be formed with suitable “feet” 68 or other projections to align in a locking engagement with a modified structural shape of the rail.

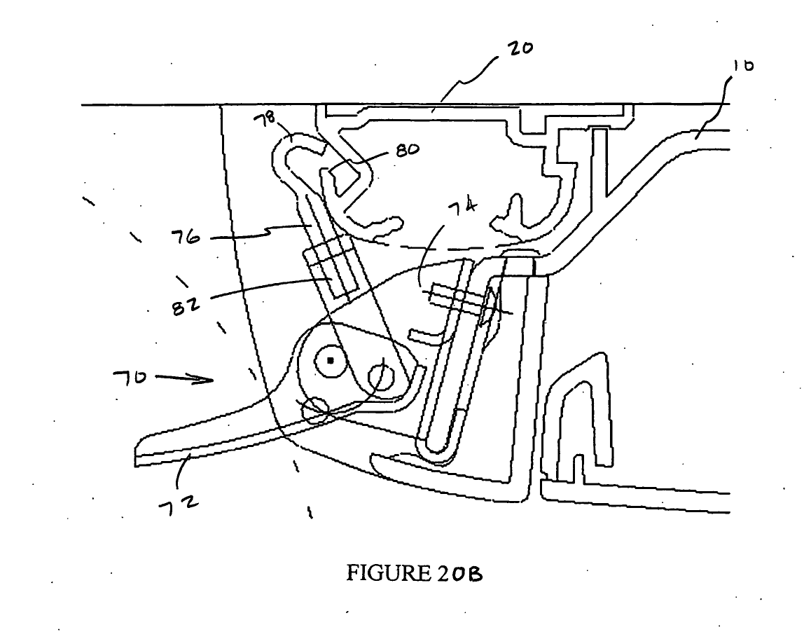

Referring to FIGS. 20A through 20C, an attachment system is shown according to another embodiment. The attachment system includes a latch device 70 positioned on one or both sides of the module 10 and configured for movement to a “stowed” or “locked” position within a compartment on the module such that the latch device 70 is generally flush with the surface of the module. The latch device 70 is configured to operate as an over-center device (e.g. “clamp,” etc.) to secure the modules 10 to the rail(s) and prevent movement of the modules in at least the vertical (e.g. Z-axis) and longitudinal horizontal (e.g. X-axis) directions. Latch device 70 has a handle member 72 (such as a lever, etc.) pivotally coupled to a bracket 74 and to a hook member 76. The hook member 76 has a “hooked” portion 78 that is configured to engage an edge 80 or other surface on the rail 20 in a secure relationship. The hook member 76 also includes a threaded interface 82 that permits the length of the hook member 76 to be adjusted to provide a desired degree of clamping force on the rail when the latching device is in the “locked” position.

The latching device is shown operating through a range of motion from an “unlocked” position to a “locked” position. The handle member 72 is rotated outwardly to move the hook member 76 upward to provide sufficient clearance for the hooked portion 78 to engage the rail 20. The handle member 72 is then rotated upwardly about the pivotal coupling toward a stowed position, which draws the hook portion 78 downward into engagement with the surface 80 on the rail 20. The desired degree of “clamping” force exerted by the hook portion 78 on the rail 20 may be adjusted by varying the appropriate lengths of the members of the latching device or by adjusting the length of the hook member 76 at the threaded interface 82.

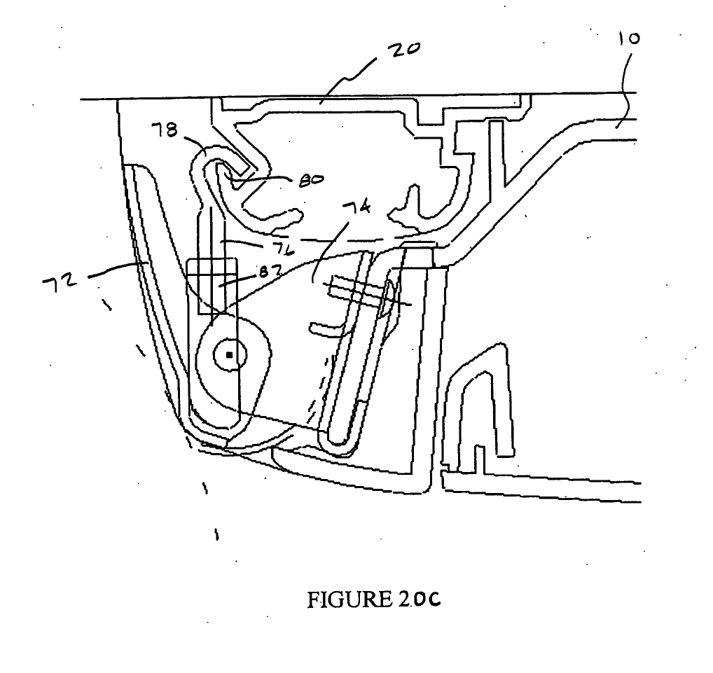

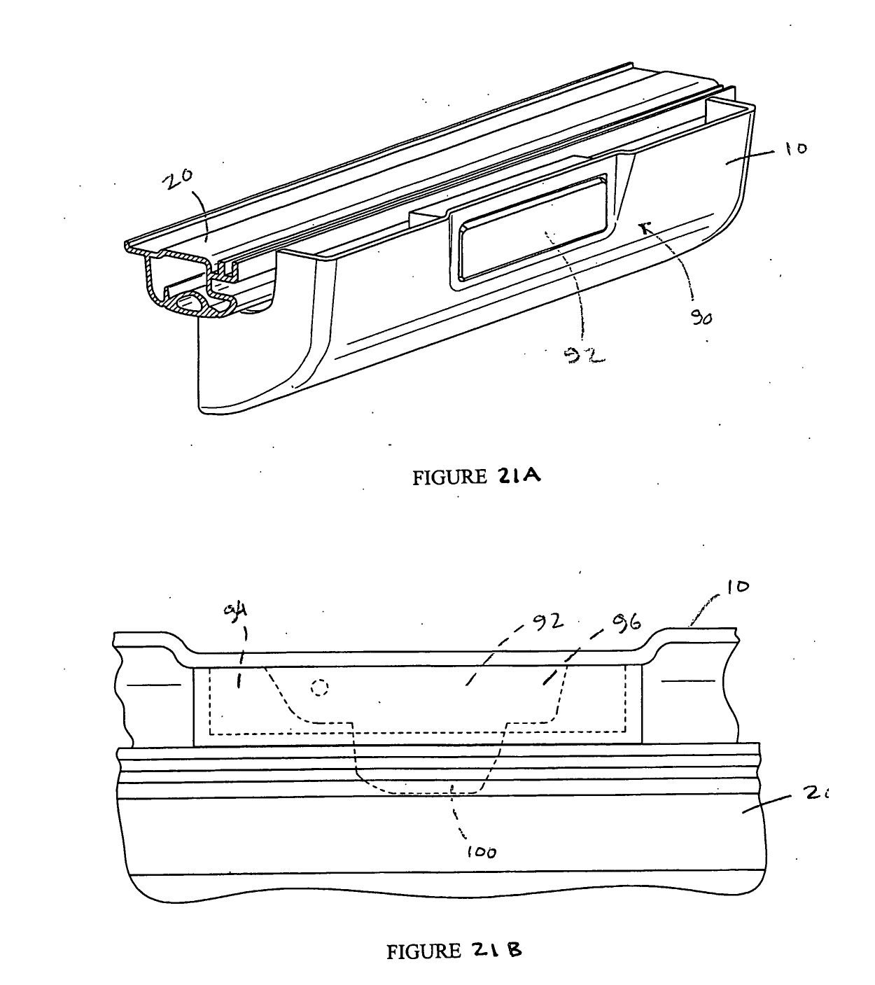

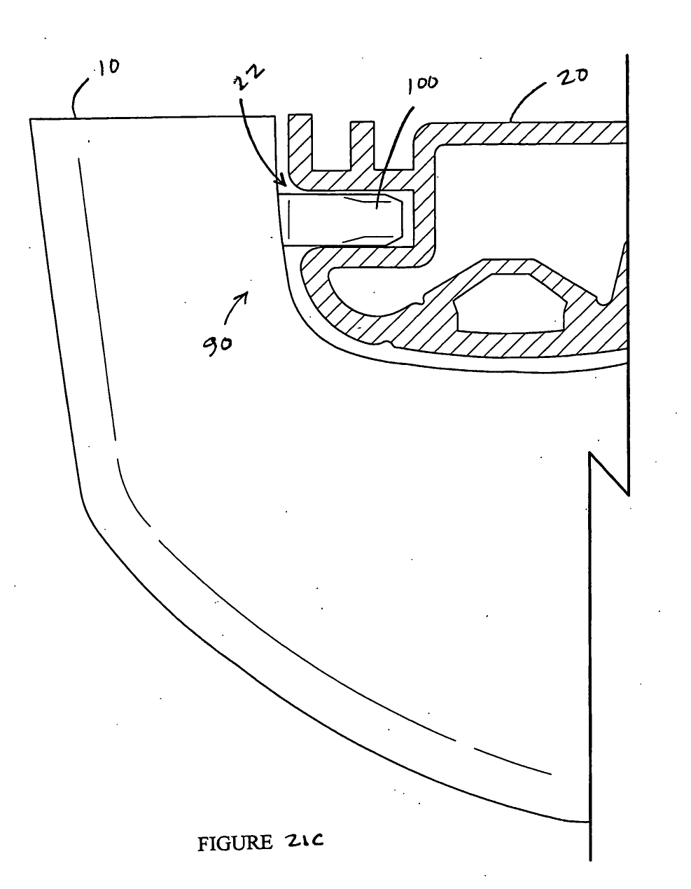

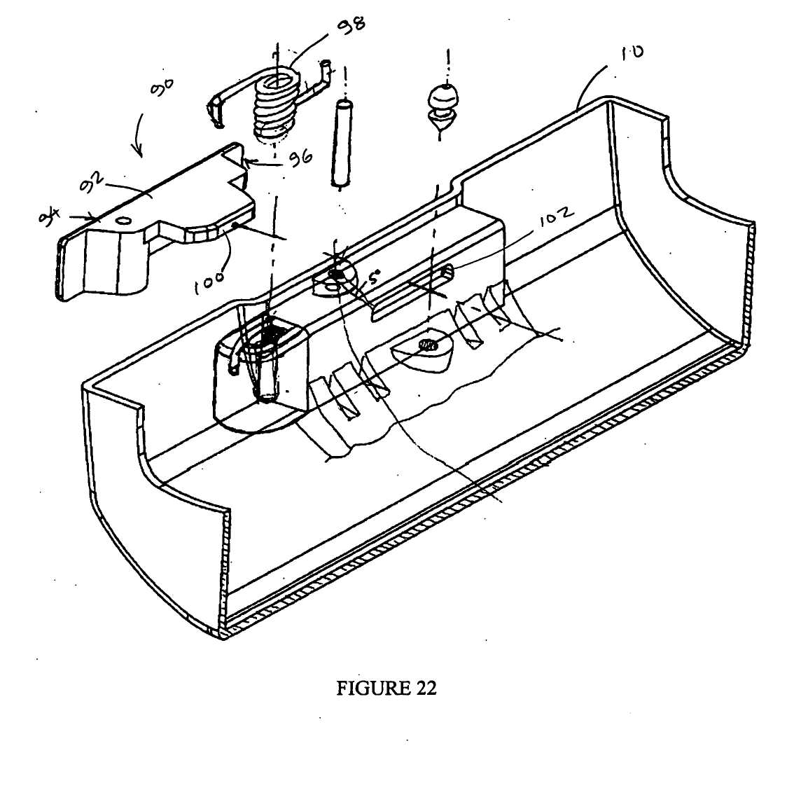

Referring to FIGS. 21A through 22, an attachment system is shown according to another embodiment. The attachment system includes a latch device 90 positioned on one or both sides of the module 10 and configured for movement to a “stowed” or “locked” position within a compartment along the side of the module so that the surface of the latch device 90 is generally flush with the surface of the module 10. The latch device 90 is configured to operate as a spring-biased, Y-axis device to secure the module to the rail(s) and prevent movement of the module in at least the vertical (e.g. Z-axis direction).

Latch device 90 has a handle member 92 having a first end 94 pivotally coupled to the module and a second end 96 biased by spring 98 inwardly toward a “locked” position on the module, where the latch device 90 is recessed generally flush with the module 10 to provide a smooth and uniform appearance. The handle member 92 has a retainer 100 (e.g. flange, etc.) disposed between the first end 94 and second end 96 that is configured to coact with the recess on the side of the rail when the retainer is in the locked position. The retainer 100 is configured to extend through an opening (shown as a slot 102) in a side of the module 10 so that the retainer 100 can extend into a recess on the side of the rail. The attachment system is intended to operate so that when the module is positioned upwardly against the rails, the retainer(s) will be forced in an outwardly direction by the contour of the rails against the spring biasing force until the module is positioned over the rails and the retainers are aligned with the recesses. The spring bias on the latch device is intended to urge the retainers into the locked position to prevent movement of the module in the vertical (e.g. Z-axis) direction. The latch device may be moved from the locked position to an unlocked position by manually rotating the second end outwardly against the spring bias to disengage the retainers from the recesses. According to any preferred embodiment, the retainer may be formed of any suitable material (e.g. steel, aluminum, plastic, etc.) in any suitable thickness to provide the desired strength and sheer loading capacity. The surface of the material of the retainer may also be provided with any suitable finish. For example, the material surface may be textured to promote a frictional interface between the retainer and the rail to inhibit movement of the module along the rail. The latching member may also be provided with projections configured to engage apertures on the rail to minimize the tendency of the modules to slide along the rails.

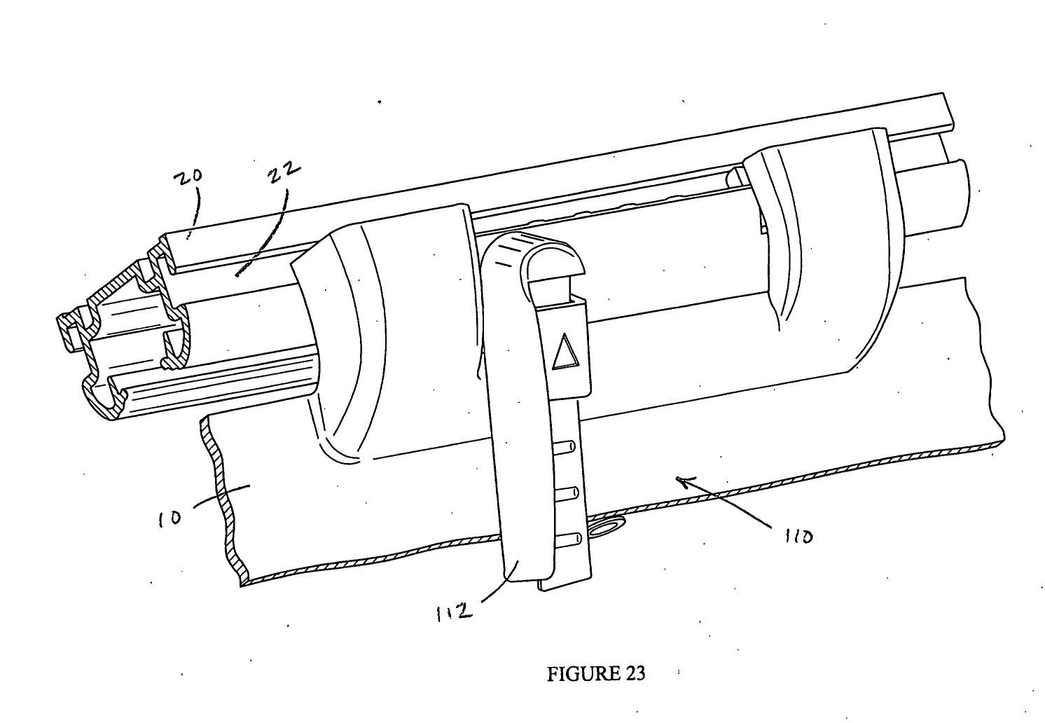

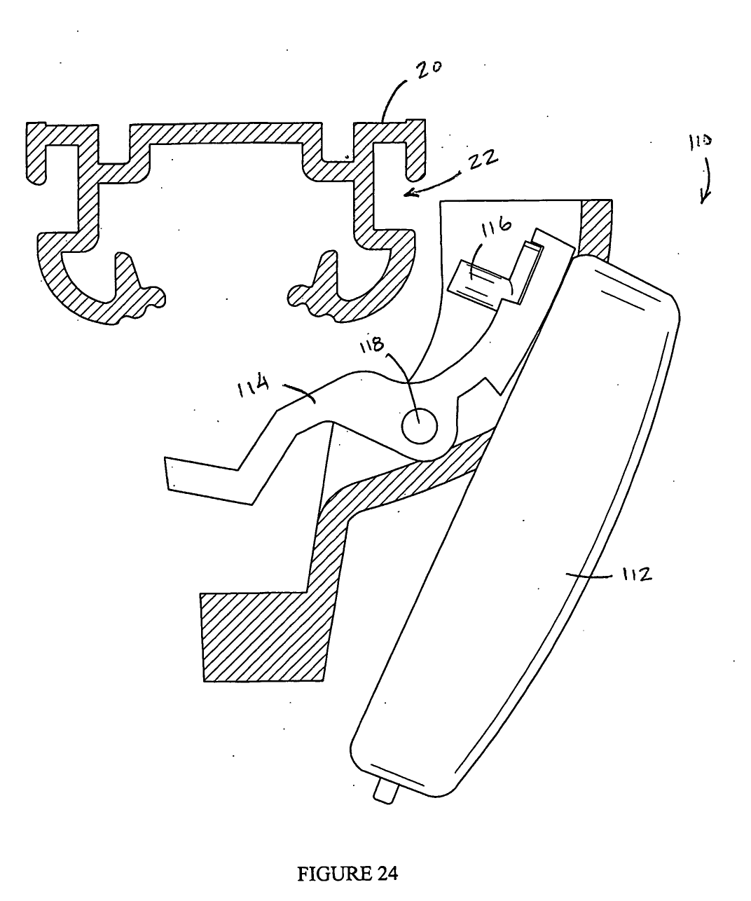

Referring to FIGS. 23 and 24, an attachment system is shown according to another embodiment. A latch device 110 includes a foot 116 (preferably a metal foot, but could be any of a variety of materials) that engages into a recess 22 (such as a groove) in the side of the rail 20. Foot 116 is rigidly mounted to a handle member 112 (such as a lever) but it is free to rotate within a wing 114. According to an exemplary embodiment, the wing is plastic, but may be any of a variety of materials. This wing 114 is attached to the module by a hinge . pin 118 that runs parallel to the rail(s) 20. As such, wing 114 is free to pivot relative to the module 10. A spring 120 is used to hold the wing 114 in the open position when the module is off the rail. As the module gets placed over the rail, an area of the wing 114 comes into contact with the rail 20 which “drives” the foot 116 into the proper location within the recess 22 on the rail 20. The user then rotates the handle member 112 to secure the foot 116 to the rail. The foot 116 is slightly longer than the groove in the rail is tall. As such, at the end of the handle rotation, the foot “bites into” (e.g., engages) the rail to provide a secure attachment. According to an exemplary embodiment, the user rotates the handle 90 degrees (i.e. quarter-turn) to secure the foot to the rail.

Operation of the latch device requires turning the handle member to attach the module to the rail once the module is in position. The foot is located into the groove in the rail when the module is loaded on to the rail. The foot “cinches” to the rail at the end of the 90 degree rotation of the handle because the length of the foot is greater than the height of the groove.

In another application of this concept, a spring is used to hold the wing in the closed position when the module is off the rail. Then, when the module is loaded onto the rail, the foot on the wing assembly would snap over the rail and into the groove. This would allow the end user to easily slide the module on the rail before they finally secure it by rotating the handle.

According to any preferred embodiment, the attachment system for a module for a vehicle is intended to provide an attachment system that is easily and conveniently accessible and operable by a wide variety of users to remove, replace, reposition, and/or install one or more modules within a vehicle, such as within or in connection with; an overhead system for a vehicle having one or more elongated members such as rails. The components of the various embodiments of the attachment system are intended to provide a lightweight, rugged, reliable and durable structure for attaching the modules to the rails (or other structure) within the vehicle. The components may be made of any suitable material such as plastic (e.g. ABS plastic, etc.), metal (e.g. aluminum, steel, etc.) or other materials that provide the desired strength to retain the modules on the rails during all appropriate loading conditions and scenarios.

It is important to note that the construction and arrangement of the elements of the various embodiments of the attachment system provided herein is illustrative only. Although only a few exemplary embodiments of the present inventions have been described in detail in this disclosure, those skilled in the art who review this disclosure will readily appreciate that many modifications are possible in these embodiments (such as variations in handle and pin member configurations, shape and size, mounting arrangements, rotational and pivoting arrangements, use of colors, combinations of shapes, etc.) without materially departing from the novel teachings and advantages of the inventions. Further, the attachment system may be used in any type of vehicle such as trucks, recreational vehicles, minivans, sport utility vehicles, passenger automobiles, etc. and at any suitable location within the vehicle (such as floors, cargo storage areas, etc.). Accordingly, all such modifications are intended to be within the scope of the invention as defined in the appended claims.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. An attachment system for attaching modules to at least one rail provided on an interior portion of a vehicle, comprising:
a latch device configured for movement between a first position and a second position; and
at least one projection extending from the latch device and configured to engage the rail member when the latch device is moved to the second position and to disengage the rail member when the latch device is moved from the second position to the first position.

2. The attachment system of claim 1 wherein the projection is a foot configured to extend into a recess within the rail member.

3. The attachment system of claim 1 wherein the latch device is configured for a quarter-turn movement between the first position and the second position.

4. The attachment system of claim 1 wherein the latch device further comprising a spring member configured to bias the projection to engage the rail member.

5. The attachment system of claim 1 wherein the latch device further comprises an extension configured to engage one or more apertures on the rail member so that the module is prevented from sliding along the rail member.

6. The attachment system of claim 1 wherein the at least one projection is two projections.

7. The attachment system of claim 6 wherein the two projections extend in generally opposite directions.

8. The attachment system of claim 1 wherein the latch device is configured for concealment beneath a movable panel.

9. The attachment system of claim 1 wherein the latch device further comprises a slot configured to receive an object for rotating the latch device.

10. The attachment system of claim 1 wherein the projection is configured to engage a side portion of the rail member.

11. The attachment system of claim 1 wherein the projection is configured to engage a flange portion of the rail member.

12. The attachment system of claim 1 wherein the projection is configured to extend through an opening in the rail member.

13. The attachment system of claim 1 wherein the latch device comprises a lever.

14. The attachment system of claim 13 wherein the lever has a first end and the lever is configured for pivotal movement about the first end.

15. The attachment system of claim 1 wherein the latch device further comprises a hook portion.

16. The attachment system of claim 15 wherein the hook portion is configured for operation as an over-center device.

17. The attachment system of claim 1 wherein the latch device further comprises a flange configured to engage a recess on the rail member.

18. The attachment system of claim 1 wherein the latch device further comprises a wing member configured to engage an outer surface of the rail member.

19. The attachment system of claim 18 wherein the projection is a foot member extending from the wing member.

20. The attachment system of claim 1 wherein the projection is a foot configured to engage the rail in an interference relationship when the latching device is in the second position.
